(19) United States
(12) Patent Application Publication
(10) Pub. No.: US 2026/0300168 A1
(43) Pub. Date: Oct. 1, 2026

(54) METHOD OF FLEXIBLE ADDRESS MAPPING FOR UTILIZING PROCESSING-IN-MEMORY AND APPARATUS THEREFOR

(71) Applicant: SEOUL NATIONAL UNIVERSITY R&DB FOUNDATION, Seoul (KR)

(72) Inventors: Jae Wook LEE, Seoul (KR); Seong Hoon Seo, Seoul (KR); Junghoon Kim, Seoul (KR); Donghyun Lee, Seoul (KR); Seonah Yoo, Seoul (KR); Seokwon Moon, Seoul (KR); Yeonhong Park, Seoul (KR)

(73) Assignee: SEOUL NATIONAL UNIVERSITY R&DB FOUNDATION, Seoul (KR)

(21) Appl. No.: 19/336,675

(22) Filed: Sep. 23, 2025

(30) Foreign Application Priority Data
Mar. 31, 2025 (KR) 10-2025-0041560

(51) Int. Cl. G06F 12/02; G06F 12/06; G06F 17/16; G06N 3/0475

(52) U.S. Cl. CPC G06F 12/0292; G06F 12/0207; G06F 12/0607; G06F 17/16; G06N 3/0475; G06F 2212/657

(57) ABSTRACT

A method of performing matrix operations including a plurality of parameters by a system-on-chip (SoC) processor and a processing-in-memory (PIM) processor inside a memory according to an embodiment may comprise the steps of: calculating a map ID on the basis of at least one among information on the matrix, information on the memory, and information on the PIM processor; allocating a huge page for representing some of the plurality of parameters; and adding the map ID to a page table entry of the huge page for the matrix operation in the SoC processor.

### BACKGROUND OF THE INVENTION

### Field of the Invention

The present invention relates to a flexible address mapping method for utilizing processing-in-memory and a device therefor, and more particularly, to a flexible address mapping technique for on-device large language model inference utilizing processing-in-memory.

Meanwhile, this application is sponsored by the national research and development project described below.
Project identification number: 2710004147
Project number: 00340008
Ministry: ministry of science and ICT
Project management (specialized) organization: National Research Foundation of Korea
Research business name: Individual Basic Research (MSIT)
Research project name: Chiplet-based Integrated Accelerator Architecture for Flexible HPC/AI Computing
Project performing organization: Seoul National University
Research period: May 1, 2024-Apr. 30, 2025
Project identification number: 2710018731
Project number: 00405857
Ministry: Ministry of Science and ICT
Project management (specialized) organization: National Research Foundation of Korea
Research business name: Group Research Support
Research project name: Sustainable Generative AI Computing Platform Laboratory
Project performing organization: Seoul National University Research period: Aug. 1, 2024-Jul. 31, 2025
Project identification number: 2710018171
Project number: 00456287
Ministry: Ministry of Science and ICT
Project management (specialized) organization: National IT Industry Planning and Evaluation Institute
Research business name: Development of Global Talent in Digital Field (R&D)
Research project name: Integrated Design of Accelerator, Network, Memory, Storage Hardware, and System Software for Large-Scale AI Model Training and Inference
Project performing organization: Industry-Academic Cooperation Foundation in Seoul National University
Research period: Jul. 1, 2024-Dec. 31, 2024

### Background of the Related Art

Large language model (LLM) inference on various edge devices including cellular phones and laptop computers is increasingly becoming important. This “on-device” inference has various advantages, such as protection of sensitive personal information stored in the devices, fast responsiveness compared to servers, model personalization, and the like. Since on-device LLM inference processes only requests of individual device users, general matrix-vector multiplication (GEMV), where the memory bandwidth is the bottleneck, occupies most of the operations.

Processing-in-memory (PIM) is a method of utilizing wide bandwidth in the memory by mounting an operation unit inside the memory, and is emerging as a solution for solving the memory bandwidth bottleneck. For example, “near-bank” DRAM PIM, in which an operation unit is mounted in each bank of DRAM, is evaluated highly likely to be adopted in actual devices, and various prototypes and commercialized products support the evaluation.

Although it is ideal to adopt the PIM in edge devices to accelerate the on-device LLM inference where memory is the major bottleneck, this generates a problem of sharing model parameters among existing system-on-chip (SoC) processors, such as graphics processing units (GPUs) or neural processing units (NPUs), and the PIM processor. The data mapping method used by the SoC processors is different from those used for PIM operations. Due to the difference in the mapping methods, a method of redundantly storing original parameters and a copy of the parameters mapped in a different way may be adopted conventionally to utilize the PIM. However, this approach is not suitable for edge devices having limited DRAM space since memory space is used duplicately.

As an alternative thereto, a method of dynamically converting the parameters and storing a copy of mapped parameters may also be used. For example, it is possible to store only original parameters, and convert, store, and use a copy of the parameters by dynamically mapping the parameters in a different way as needed. However, as the method dynamically changes the mapping and stores a copy of the parameters every time, it increases both the response time and processing time of processing (e.g., processing related to LLM inference).

As a result, in order for the SoC processor to perform complex operations by utilizing the PIM, conventionally, it is possible to use a method of (i) redundantly storing a copy of parameters mapped in a different type in the memory, or (ii) dynamically changing the data mapping. However, these methods have a problem of generating cost from the aspect of storage space and/or processing time.

### PATENT DOCUMENT

Korean Patent Registration No. 10-2695927

### SUMMARY OF THE INVENTION

An object of the present invention is to solve the problem of requiring a different memory layout when a Soc processor or a PIM processor accesses the same matrix parameter data to accelerate on-device LLM inference by utilizing PIM.

According to an embodiment of the present invention, an object is to provide a system having practicality and scalability by proposing flexible DRAM address mapping of huge page units and also proposing changes in the memory system needed for DRAM address mapping.

Another object of the present invention is to efficiently implement matrix operations used for LLM inference through flexible DRAM address mapping, and apply various forms of data placement optimization, which can be expressed through flexible address mapping, so that it can be extended to other applications, in addition to the LLM inference.

Meanwhile, the problems to be solved by the present invention or the objects of the present invention are not limited to those mentioned above, and the matters described above should be understood as exemplary.

To accomplish the above objects, according to one aspect of the present invention, there is provided a method of performing matrix operations including a plurality of parameters by a system-on-chip (SoC) processor and a processing-in-memory (PIM) processor inside a memory, and the method may comprise the steps of: calculating a map ID on the basis of at least one among information on the matrix, information on the memory, and information on the PIM processor; allocating a huge page for representing some of the plurality of parameters; and adding the map ID to a page table entry of the huge page for the matrix operation in the SoC processor.

In addition, information on the matrix may include information on a dimension of the matrix, and the map ID may be a value representing how much a bit in charge of bank interleaving inside the memory is apart from a chunk column.

In addition, the step of calculating a map ID may be performed by a mapping selector, and the step of allocating a huge page and the step of adding the map ID to a page table entry of the huge page may be performed by a memory allocator.

In addition, the method may further comprise, before the step of calculating a map ID, the step of transmitting a memory allocation request by a user program to the mapping selector, together with information on the matrix.

In addition, the method may further comprise, after the step of adding the map ID to a page table entry of the huge page, the step of returning a virtual address of the huge page allocated by the memory allocator to a user program.

In addition, the matrix operation may include matrix-matrix multiplication and matrix-vector multiplication, wherein the matrix-matrix multiplication may be performed by the SoC processor, and the matrix-vector multiplication may be performed by the PIM processor.

In addition, the matrix operation may be a weight matrix operation used for large language model (LLM) inference.

In addition, the LLM inference may include a prefill phase and a decode phase, wherein the prefill phase may include the matrix-matrix multiplication performed by the SoC processor, and the decode phase may include the matrix-vector multiplication performed by the PIM processor.

In addition, the LLM inference may be performed by a single edge device.

In addition, information on the matrix may include at least one among information on a dimension of the matrix and information on a data type of the matrix.

In addition, information on the memory may include at least one among information on a size of the huge page of the memory, information on the number of channels of the memory, information on the number of ranks of the memory, and information on the number of banks of the memory.

In addition, information on the PIM processor may include information on a chunk column.

In addition, the map ID may be determined to be different according to whether partitioning is needed, by comparing the size of the huge page with respect to a total number of banks in the memory with a row size of the matrix.

In addition, the method may further comprise the steps of: receiving a virtual address for storing or loading the matrix from a user program, after the step of adding the map ID to a page table entry of the huge page; determining a physical address corresponding to the virtual address; and determining a DRAM address of the memory corresponding to the physical address on the basis of the physical address and the map ID.

In addition, the step of determining a DRAM address of the memory corresponding to the physical address may be performed by a memory controller, a multiplexer of the memory controller may receive the map ID as an input, and the memory controller may include a register for storing the map ID.

In addition, mapping between the DRAM address of the memory and the physical address may be abstracted to the user program.

According to an embodiment of the present invention, there is provided a computing device comprising, and the computing device may comprise: a system-on-chip (SoC) processor; and a memory including a processing-in-memory (PIM) processor, wherein when a command related to a matrix operation stored in the memory is performed by the Soc processor and the PIM processor, the computing device may perform: an operation of calculating a map ID on the basis of at least one among information on the matrix, information on the memory, and information on the PIM processor; an operation of allocating a huge page for representing some of the plurality of parameters; and an operation of adding the map ID to a page table entry of the huge page for the matrix operation in the SoC processor.

According to an embodiment of the present invention, there is provided a computer program stored in a non-transitory computer-readable recording medium, and the computer program may execute operations of performing a matrix operation including a plurality of parameters by a system-on-chip (SoC) processor and a processing-in-memory (PIM) processor in the memory when the computer program is performed by a computing device, and the operations may include: an operation of calculating a map ID on the basis of at least one among information on the matrix, information on the memory, and information on the PIM processor; an operation of allocating a huge page for representing some of the plurality of parameters; and an operation of adding the map ID to a page table entry of the huge page for the matrix operation in the SoC processor.

### BRIEF DESCRIPTION OF THE DRAWINGS

FIG. 1 is a view showing the configuration of a device having a processor outside a memory and a processor inside a memory according to an embodiment of the present invention.

FIG. 2 is a view showing an example of the structure of a transformer layer.

FIG. 3 is a view showing an example of an LLM inference process distinguished as a prefill phase and a decode phase.

FIG. 4 is a graph showing the degree of decrease in the LLM inference time, which can be achieved by utilizing the PIM.

FIG. 5 is a graph exemplary showing a view of arranging matrix parameters on DRAM for the operation of a PIM processor.

FIG. 6 is a graph showing delays in the response time generated when data used by a PIM processor and a SoC processor is replaced.

FIG. 7 is a flowchart: illustrating a method of performing a matrix operation including a plurality of parameters by a Soc processor and a PIM processor inside a memory according to an embodiment of the present invention.

FIG. 8 is a flowchart illustrating a method of performing a matrix operation including a plurality of parameters by a SoC processor and a PIM processor inside a memory according to an embodiment of the present invention.

FIGS. 9a-9c are block diagrams schematically showing a process of performing a matrix operation including a plurality of parameters by a Soc processor and a PIM processor inside a memory according to an embodiment of the present invention.

FIG. 10 is a program code showing an implementation example of an algorithm for calculating a map ID according to an embodiment of the present invention.

FIGS. 11a-11b are views showing DRAM address mapping optimized for two exemplary types of PIM architecture.

FIG. 12 is a view showing an implementation example of modifying a page table entry to transmit a map ID to a memory controller.

FIG. 13 is a view showing a modified example of a memory controller needed to change the DRAM address mapping according to a map ID.

FIGS. 14 to 16 are views showing the technical effects of flexible address mapping technique according to an embodiment of the present invention compared to existing techniques.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments of the present invention will be described with reference to the accompanying drawings. However, it should be understood that this is not intended to limit the present invention to specific embodiments, but to include various modifications, equivalents, and/or alternatives of the embodiments of the present invention.

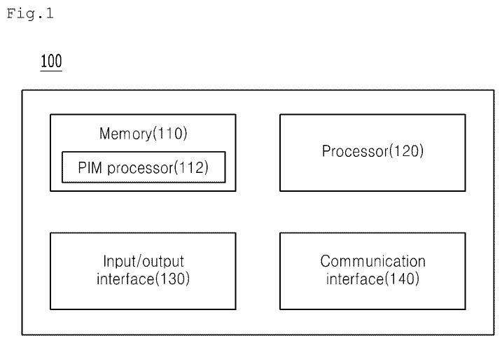

FIG. 1 is a view showing the configuration of a device 100 having a processor (e.g., SoC processor) outside a memory and a processor (e.g., PIM processor) inside a memory according to an embodiment.

Referring to FIG. 1, the device 100 according to an embodiment may include a memory 110, a processor 120, an input/output interface 130, and a communication interface 140. The device 100 may be a computing device.

The memory 110 may include a PIM processor 112. The PIM processor inside the memory 110 is distinguished from the processor 120 outside the memory 110 shown in FIG. 1.

The memory 110 may be, for example, DRAM, but this is only exemplary and the present invention is not limited thereto. However, in this specification, it will be described below assuming that the memory 110 is DRAM for convenience of explanation.

The memory 110 may store data acquired from an external device or data generated by itself. The memory 110 may store commands/data that may perform operations of the processor 120. In addition, the memory 110 may store commands/data that may perform operations of the PIM processor 112 of its own. For example, the memory 110 may store various information for implementing a method of performing matrix operations including a plurality of parameters by the Soc processor and the PIM processor in the memory described below.

The processor 120 is a computing device that controls the overall operation. The processor 120 may execute commands stored in the memory 110. The processor 120 may be a single-core processor or a multi-core processor including a plurality of cores. In addition, the processor 120 may be a SoC processor.

The input/output interface 130 may include a hardware interface or software interface for inputting or outputting information.

The communication interface 140 allows to transmit and receive information through a communication network. To this end, the communication interface 140 may include a wireless communication module or a wired communication module.

The device 100 may be implemented in various forms of devices that can perform operations through the processor 120 and/or the PIM processor 112 and transmit and receive information through a network. For example, the device may be implemented in the form of a server, a computer device, a portable communication device, a smartphone, a portable multimedia device, a laptop computer, a tablet PC, or the like, but it is not limited to these examples.

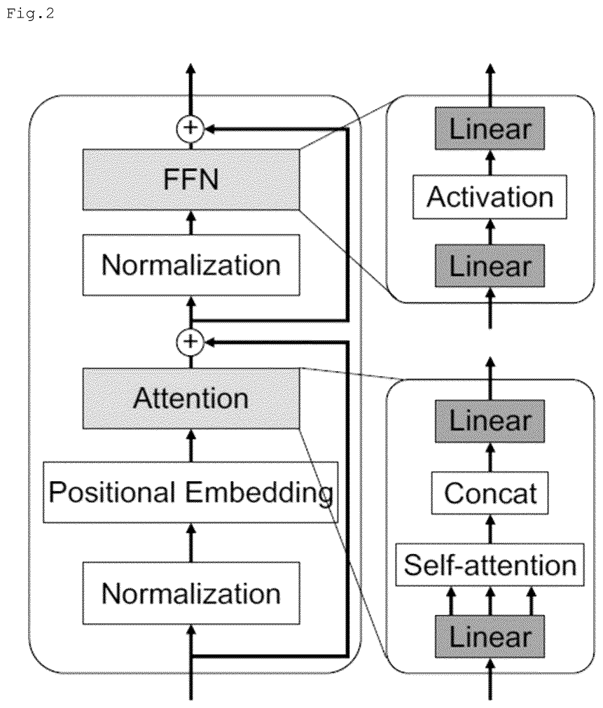

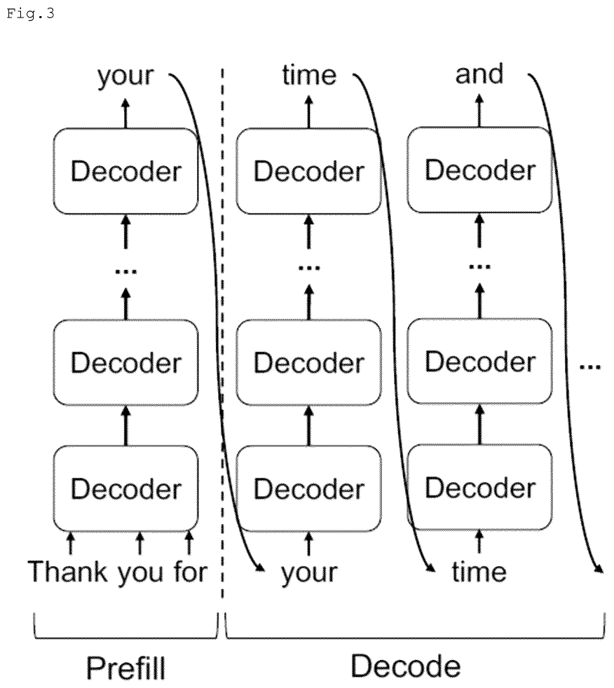

FIG. 2 is a view showing an example of the structure of a transformer layer, and FIG. 3 is a view showing an example of an LLM inference process distinguished as a prefill phase and a decode phase.

Today, most of large language model (LLM) inferences may be commonly configured of a plurality of transformer decoder layers. As shown in FIG. 2, the core operations of the transformer decoder layer in the transformer layer structure may include linear operation and self-attention operation. Among these, the operation that occupies a significant portion of on-device inference time is the linear operation. In the case of on-device inference, only the requests of the user of a corresponding device are processed, and the characteristics of linear operation in the on-device LLM inference, which processes only the requests of the user of the device, vary according to the phase of the LLM inference process.

As shown in FIG. 3, LLM inference is divided into a prefill phase, which processes several tokens at a time, and a decode phase, which generates one token at a time. The former performs general matrix-matrix multiplication (GEMM), while the latter performs general matrix-vector multiplication (GEMV). Although the prefill phase is performed only once for each request, the decode phase is performed repeatedly for each generated token, so that the decode phase occupies most of the overall inference time. Therefore, the matrix-vector multiplication may be considered as the core operation that determines performance of the LLM inference.

As the matrix-vector multiplication is an operation of little data reuse and low operation intensity, memory bandwidth of the device becomes a bottleneck. Therefore, when this operation is processed by a SoC processor (e.g., processor 120) outside the memory (e.g., memory 110), the cost of transmitting and receiving data is enormous, the overall operation efficiency is lowered. To improve this shortcoming, a processor inside the memory (e.g., PIM processor 112) may be utilized. PIM is a technique of utilizing internal bandwidth by mounting an operation unit inside the memory. For example, among various types of PIM, a “near-bank” DRAM PIM, which arranges an operation unit in each bank of DRAM, may be considered. The near-bank DRAM PIM is considered as being the closest to commercialization.

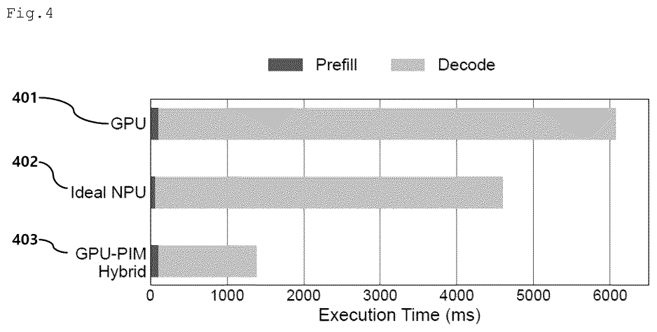

FIG. 4 is a graph showing the degree of decrease in the LLM inference time, which can be achieved by utilizing the PIM.

As can be confirmed in FIG. 4, when a PIM processor is utilized, memory bottleneck operations that are difficult to accelerate with only a conventional Soc processor can be accelerated, and the time required for inference can be reduced dramatically. For example, comparing a case of performing LLM inference using a GPU as a SoC processor (401), a case of performing LLM inference using an ideal NPU (402), and a case of performing LLM inference using a GPU, which is a type of the Soc processor, and a PIM processor in combination (403) as shown in FIG. 4, it can be seen that the execution speed decreases toward the latter cases. In addition, it can be confirmed that the factor that affects the execution speed is the decode phase rather than the prefill phase.

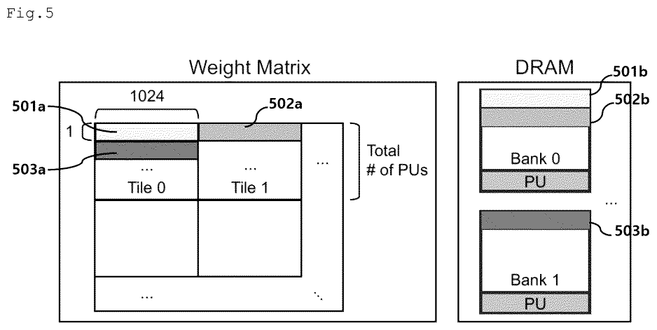

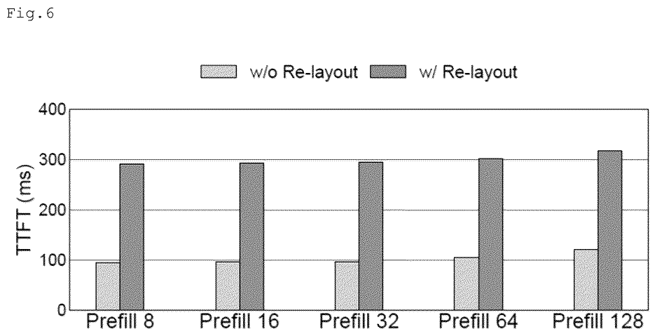

FIG. 5 is a graph exemplary showing a view of arranging matrix parameters on DRAM for the operation of a PIM processor, and FIG. 6 is a graph showing delays in the response time generated when data used by a PIM processor and a SoC processor is replaced.

As can be confirmed in FIG. 5, it is general that in order to perform matrix-vector operations using PIM, parameters of a matrix used for LLM inference need to be arranged inside the DRAM in a specific format. For example, this may be different from the DRAM address mapping typically used by a SoC processor. For example, when stored inside a memory such as DRAM, some parameters 501a, 502a and 503a of the weight matrix may be stored according to a specific pattern. For example, some parameters 501b and 502b may be stored in bank 0, and the other parameters 503 may be stored in bank 1.

LLM inference should be able to perform both the matrix-matrix multiplication, which is advantageous to be performed by the Soc processor as the operation intensity is high, and the matrix-vector multiplication, which is advantageous to be performed by the PIM processor as the operation intensity is low, for the same LLM parameters (e.g., parameters included in the weight matrix). Therefore, in order to perform LLM inference on a heterogeneous platform configured of a Soc processor and a PIM processor, a type of hardware that performs a specific operation should be considered at the time point when the operation is performed (e.g., whether it is a SoC processor or a PIM processor), and a work of changing data placement to be suitable for the hardware needs to be performed.

Meanwhile, as shown in FIG. 6, when the data replacement task is performed, there is a problem in that a delay in response time, which is represented by time-to-first-token (TTFT), is generated.

For example, data replacement may be a technique of storing data in the memory in a format suitable for the PIM processor, and dynamically replacing and storing the data in a format suitable for the SoC processor only in the prefill phase. However, in this case, the time required to generate the first token, i.e., time-to-first-token (TTFT), increases due to the data replacement cost, and this significantly reduces the responsiveness of the inference.

In the on-device LLM inference, TTFT is known as an important metric that impacts user experience more than the total inference time. It is since the speed of the LLM generating tokens is generally faster than the speed of the user reading or hearing a result generated by the LLM. In other words, the user feels that the time required for producing the first word is greater than the total time required for completing the inference.

Accordingly, embodiments of the present invention provide a flexible address mapping technique that allows both the Soc processor and the PIM processor to confirm a plurality of parameters included the matrix operation without performing data replacement like this.

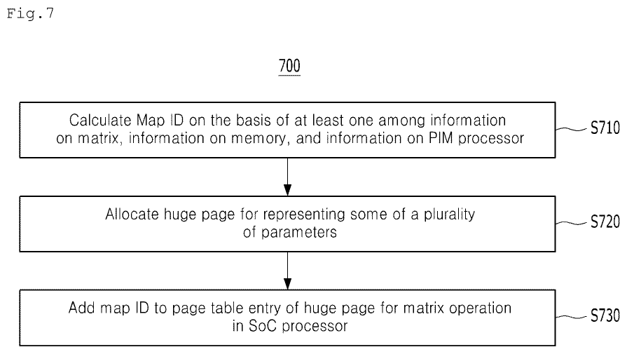

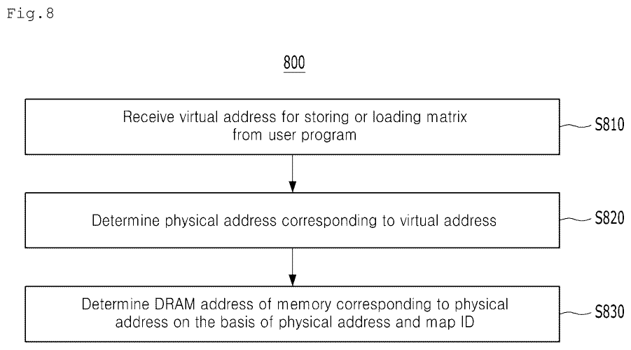

Hereinafter, an embodiment of an exemplary method of the present invention will be described with reference to FIGS. 7 and 8. The steps disclosed in FIGS. 7 and 8 are only a preferred embodiment for achieving the objects of the present invention, and some steps may be added or deleted as needed, and any one step may be included and performed in another step. The order of the operations disclosed in FIGS. 7 and 8 is only an order arranged for convenience of understanding, and this order is not limited to a time-series order, and the order may be changed to perform the operation in a different way according to the choice of a designer.

FIG. 7 is a flowchart illustrating a method (700) of performing a matrix operation including a plurality of parameters by a SoC processor and a PIM processor inside a memory according to an embodiment of the present invention. For example, FIG. 7 is a flowchart illustrating an operation performed by the Soc processor 120 and the PIM processor 112 of the device 100 according to an embodiment of the present invention as shown in FIG. 1 in association with the memory 110.

At step S710, a map ID may be calculated on the basis of at least one among information on the matrix, information on the memory, and information on the PIM processor. According to an embodiment, information on the matrix may include information on the dimension of the matrix. The map ID may be a value representing how much a bit in charge of bank interleaving inside the memory is apart from the chunk column.

At step S720, a huge page for representing some of the plurality of parameters may be allocated.

At step S730, the map ID may be added to the page table entry of the huge page for the matrix operation in the SoC processor.

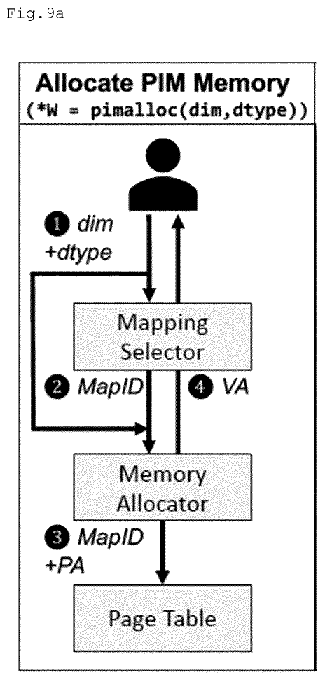

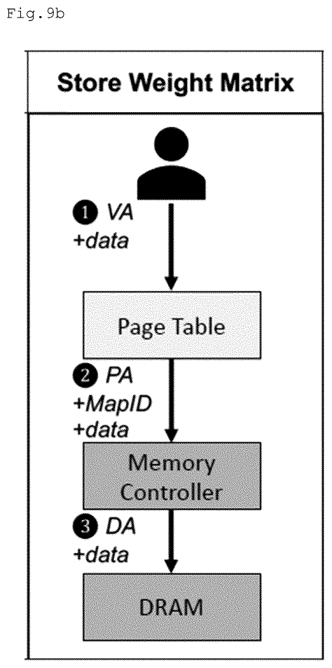

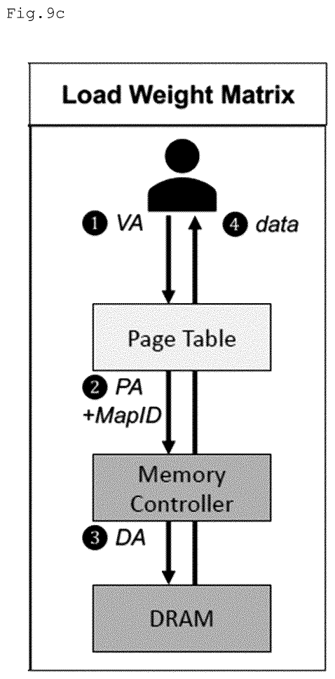

The step of calculating a map ID (S710) may be performed by a mapping selector, and the step of allocating a huge page (S720) and the step of adding the map ID to the page table entry of the huge page (S730) may be performed by a memory allocator. The specific operation thereof will be described below with reference to FIGS. 9a-9c.

Meanwhile, although not shown in FIG. 7, the method (700) may further include, before the step of calculating a map ID (S710), a step of transmitting a memory allocation request by a user program to the mapping selector, together with information on the matrix. For example, the user program may transmit a memory allocation request to the mapping selector using a PIM memory allocation function such as pimalloc(dim, dtype).

In addition, although not shown in FIG. 7, the method (700) may further include, after the step of adding the map ID to the page table entry of the huge page (S730), a step of returning a virtual address of the huge page allocated by the memory allocator to the user program. This virtual address may be used in the process of mapping among the virtual address (VA), physical address (PA), and DRAM address (DA) in the exemplary embodiment shown in FIG. 8 as described below.

FIG. 8 is a flowchart illustrating a method (800) of performing a matrix operation including a plurality of parameters by a SoC processor and a PIM processor inside a memory according to an embodiment of the present invention. For example, FIG. 8 is a flowchart illustrating the operation performed by the Soc processor 120 and the PIM processor 112 of the device 100 according to an embodiment of the present invention in association with the memory 110 as shown in FIG. 1. The method (800) of FIG. 8 may be performed after the method (700) of FIG. 7.

At step S810, after the step of adding the map ID to the page table entry of the huge page (S730), a virtual address for storing or loading a matrix may be received from the user program.

At step S820, a physical address corresponding to the virtual address may be determined.

At step S830, a the memory DRAM address of corresponding to the physical address may be determined on the basis of the physical address and the map ID.

FIGS. 9a-9c are block diagrams schematically showing a process of performing a matrix operation including a plurality of parameters by a Soc processor and a PIM processor inside a memory according to an embodiment of the present invention. For example, FIG. 9a may correspond to the embodiment of FIG. 7, and FIG. 9b and FIG. 9c may correspond to the embodiment of FIG. 8.

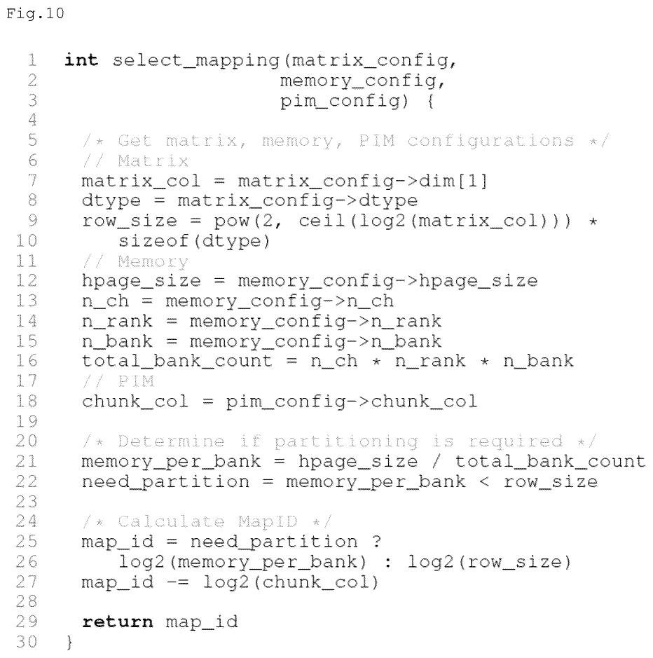

As shown in FIGS. 9a-9c, the data allocation process may follow the flow of FIG. 9a. When the dimension of a matrix to be shared between the SoC processor and the PIM processor and the microarchitecture of the PIM processor are specified, the mapping selector may calculate a Map ID (MapID) for the matrix. An exemplary algorithm for determining the Map ID is described below in more detail with reference to FIG. 10.

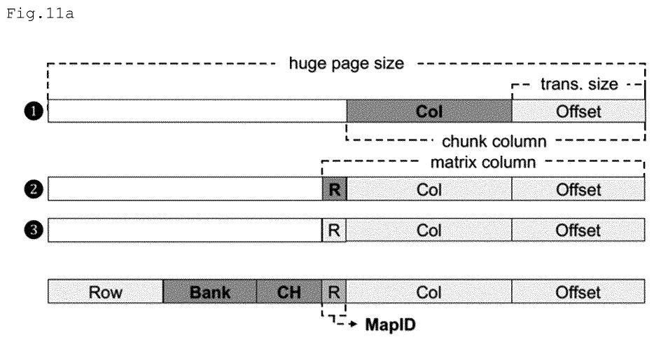

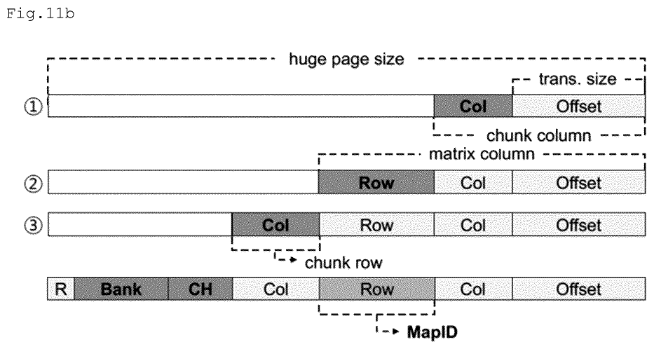

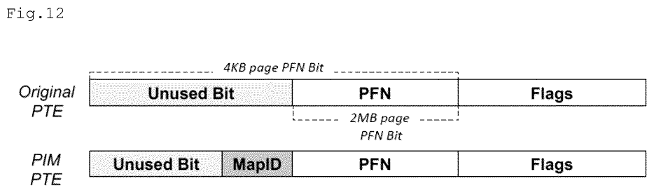

The mapping selector requests the operating system to allocate memory in units of huge pages, and a modified memory allocation function (e.g., pimalloc) may add a map ID to the page table entry (PTE) of the huge page. The process of allocating a huge page and adding a map ID to the page table entry will be described below in more detail with reference to FIGS. 11a, 11b and 12.

From the perspective of a program executed on the SoC processor, a change in the DRAM address mapping is abstracted and invisible as shown in FIG. 9b and FIG. 9c. Therefore, the user program accesses data on the layer of the virtual address (VA) in the same manner as before, and existing user programs may operate as they are without considering the translation between the physical address (PA) in the lower layer and the DRAM address (DA) at all.

For example, when a request for storing parameters of a weight matrix (e.g., FIG. 9b) or a request for loading the parameters (e.g., FIG. 9c) is received from the user program, both of these requests are initiated by transmitting a virtual address (VA) (corresponding to $810 of FIG. 8). A physical address (PA) corresponding to the virtual address (VA) may be determined through the page table (corresponding to S820 of FIG. 8), and a DRAM address (DA) of the memory may be determined based on the physical address (VA) and the map ID (MapID) (corresponding to S830 of FIG. 8).

FIG. 10 is a program code showing an implementation example of an algorithm for calculating a map ID according to an embodiment of the present invention.

Information on the matrix (matrix_config) may include at least one among information on the dimension of the matrix (matrix_config→dim) and information on the data type of the matrix (matrix_config→dtype).

Information on the memory (memory_config) may include at least one among information on the size of the huge page of the memory (memory_config→hpage_size), information on the number of channels of the memory (memory_config→n_ch), information on the number of ranks of the memory (memory_config→n_rank), and information on the number of banks of the memory (memory_config→n_bank).

Information on the PIM processor (pim_config) may include information on the chunk column (pim_config→chunk_col).

The map ID (map_id) may be determined to be different according to whether partitioning is needed, by comparing the size of the huge page (hpage_size/total_bank_count) with respect to the total number of banks in the memory with the row size of the matrix (row_size). For example, the map ID (map_id) may be determined to be different according to the conditional statement described in lines 25 to 27 of FIG. 10.

FIGS. 11a and 11b are views showing DRAM address mapping optimized for two exemplary types of PIM architecture. For example, FIG. 11a is an example of the AiM architecture, and FIG. 11b is an example of the HBM-PIM architecture.

Referring to FIGS. 11a and 11b, a process of identifying DRAM address mapping, which arranges LLM parameters included in the weight matrix to be suitable for the operation of the PIM processor in the LLM inference process, and expressing the type of the mapping as a map ID is shown.

As described above, the pattern of DRAM address mapping that achieves an optimized matrix arrangement for the operation of the PIM processor can be grasped and expressed as a Map ID under the constraint that the program running on the Soc processor is not modified. As can be confirmed in FIGS. 11a and 11b, the optimized DRAM address mapping is affected by the micro-architecture of the PIM and the dimension of the matrix, and may be generalized and expressed as a Map ID for various cases. When the LLM model is loaded on the memory for the first time, the mapping selector according to an embodiment of the present invention grasps DRAM address mapping required by each matrix on the basis of the architecture of the PIM and the dimension of the LLM parameter matrixes, and may express the DRAM address mapping in the form of a Map ID.

FIG. 12 is a view showing an implementation example of modifying a page table entry to transmit a map ID to a memory controller. As described above, memory allocation is performed in units of huge pages for LLM parameters of the matrix, and a map ID may be added to the huge page and transmitted to the memory controller.

Since the SoC processor may perform various operations in addition to the LIM inference, the DRAM address mapping may be changed only for the LLM parameters shared by the SoC processor and the PIM processor.

In the case of edge devices such as smartphones, laptop computers, and the like, all the bits of channel, rank, bank, and column that determine the placement in the DRAM may exist in the 21 bits constituting a single huge page of a 2 MB size. Therefore, when memory for LLM parameters is allocated using the huge page, the DRAM address mapping may be changed locally without changing the overall DRAM address mapping of the device significantly.

In order to pass the Map ID determined by the mapping selector to the memory controller, the memory allocation function of the operating system can be modified by adding the Map ID in the remaining area of the page table entry (PTE) unused due to the utilization of the huge page as shown in FIG. 12.

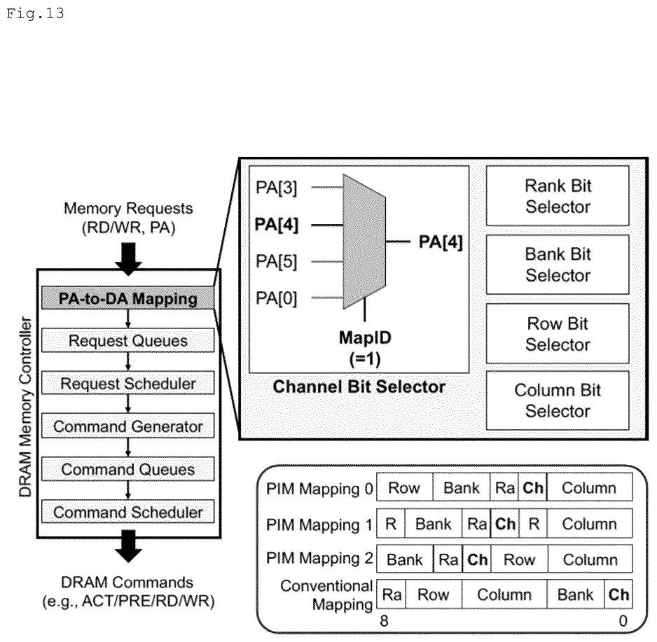

FIG. 13 is a view showing a modified example of a memory controller needed to change the DRAM address mapping according to a map ID.

As shown in FIG. 13, changing the DRAM address mapping in units of huge pages may be implemented by simply modifying the existing memory controller. A hardware module that may use a different mapping according to the map ID (MapID) may be added to the PA-to-DA mapping area, in which a physical address (PA) is converted into a DRAM address (DA) by the memory controller, as shown in FIG. 13.

In this way, the memory controller may implement the embodiments of the present invention with minimal modifications while maintaining its existing form. For example, since such modifications require only addition of a multiplexer and a register, it can be implemented almost without increasing the area and power consumption of the memory controller. In other words, the step of determining the DRAM address of the memory corresponding to the physical address is performed by the memory controller, the multiplexer of the memory controller receives the map ID as an input, and the memory controller includes a register for storing the map ID, so that the other part of the existing memory controller can be maintained as is.

According to an embodiment of the present invention, the matrix operation may be a weight matrix operation used for LLM inference, and may include matrix-matrix multiplication and matrix-vector multiplication. According to the flexible address mapping technique using a map ID according to an embodiment of the present invention as described above, the matrix-matrix multiplication may be performed by the SoC processor, and the matrix-vector multiplication may be performed by the PIM processor.

The matrix-matrix multiplication may correspond to the prefill phase, and the matrix-vector multiplication may correspond to the decode phase. In other words, the LLM inference may include a prefill phase and a decode phase, wherein the prefill phase may include matrix-matrix multiplication performed by the SoC processor, and the decode phase may include matrix-vector multiplication performed by the PIM processor.

In this way, in an embodiment of the present invention, LLM parameters that should be shared by two types of heterogeneous processors are allocated to huge pages, and address mapping optimized for PIM, rather than the existing DRAM address mapping of the Soc processor, is used for these huge pages. This allows the Soc processor to access the LLM parameters without a separate program modification and without data replacement cost. Furthermore, since data is arranged even in the PIM processor in a form optimized for the PIM architecture, operations where the memory is a bottleneck can be accelerated to the maximum.

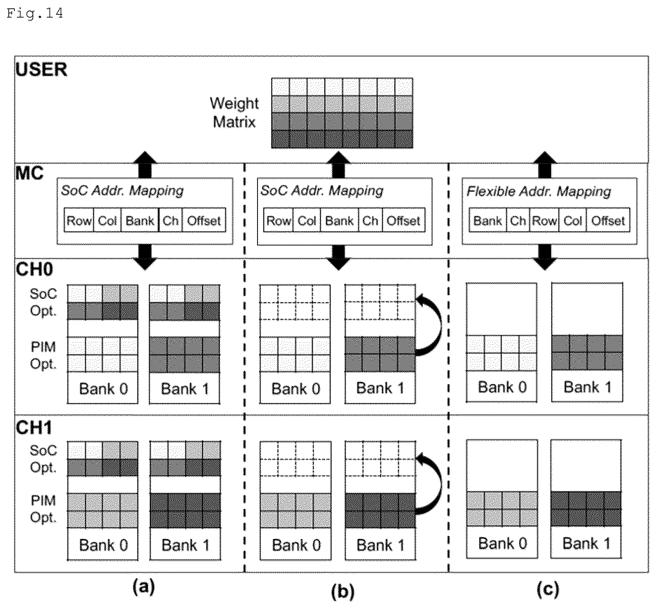

FIGS. 14 to 16 are views showing the technical effects of a flexible address mapping technique according to an embodiment of the present invention compared to existing techniques.
(a) of FIG. 14 represents the method of redundantly storing identical data for each mapping in an abstract way. With regard to the parameters of the weight matrix used in the user program, the data placement pattern optimized for the SoC processor (Soc Opt.) and the data placement pattern optimized for the PIM processor (PIM Opt.) are different in each channel (CH0, CH1) and in each bank (Bank0, Bank1) as shown in (a) of FIG. 14. Since different placement patterns of data are stored redundantly, there is a limitation in that it is difficult to adopt the method of (a) of FIG. 14 in the on-device LLM inference.
(b) of FIG. 14 represents a method of dynamically performing data replacement in an abstract way. In the structure shown in (b) of FIG. 14, although data is not redundantly stored continuously, cost for dynamically changing the data placement is generated. Accordingly, this also increases both the inference response time and processing time.
(c) of FIG. 14 shows that the flexible address mapping technique according to an embodiment of the present invention overcomes the shortcomings of existing techniques. The flexible address mapping technique according to an embodiment of the present invention may also be referred to as a Flexible Address Mapping for Cooperative Inference (FACIL).

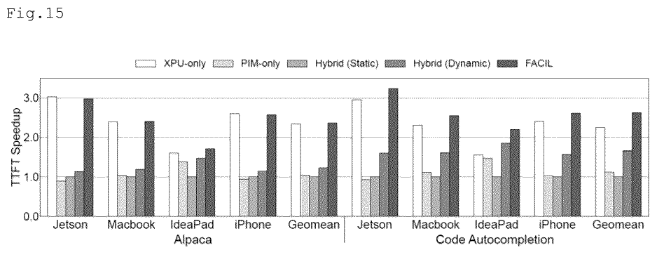

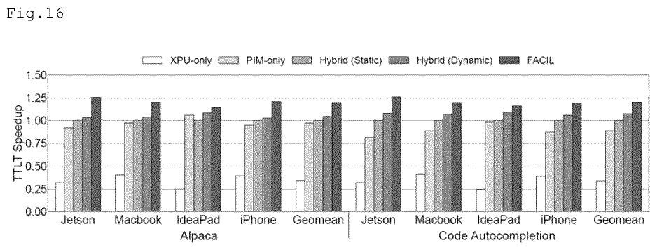

FIG. 15 is a graph showing improvement in response time (TTFT) of LLM inference compared to the baseline, and FIG. 16 is a graph showing improvement in processing time of LLM inference compared to the baseline.

Here, performance is evaluated on four edge devices having different characteristics. Specifically, performance is measured by utilizing a PIM simulator, in addition to measurements performed by real devices. The effects of the invention are confirmed by measuring the response time and processing time of the LLM inference on the Alpaca dataset and the RealHumanEval dataset, which can be regarded as an example of a virtual assistant and autocomplete utilizing LLM.

As can be confirmed in FIG. 15, the embodiment of the present invention has an effect of reducing the response time by more than twice compared to the SoC-PIM baseline. The graph marked as “FACIL” in FIG. 15 is a graph of the embodiment of the present invention. Compared to the baseline marked as “Hybrid (Static)”, the response time measured by TTFT for each request is shortened by an average of 2.37 and 2.63 times for each dataset.

In an LLM service such as a chatbot or a virtual assistant where users interact with devices, response time has the greatest impact on the user experience. It is since the speed of the LLM generating tokens is generally faster than the speed of the user reading or hearing a generated result. Therefore, in this case, response time represented by TTFT, rather than total processing time, can be a core performance metric in an on-device inference.

In addition, as shown in FIG. 16, reduction of about 20% in the processing time and utilization of the PIM, compared to the SoC-PIM baseline, can be reconfirmed in the embodiment of the present invention. For example, the embodiment of the present invention may reduce the processing time for each query by about 20% in both cases of two datasets. In addition, as the processing time can be reduced as much as 3.5 times or more compared to a case of utilizing only the SoC processor, utilization of the PIM in accelerating the on-device LLM inference can be reconfirmed.

As described above, the embodiments of the present invention propose a method that allows a SoC processor and a PIM processor to share LLM parameters without additional cost. For example, a method of allocating data shared by different types of hardware to a huge page and converting DRAM address mapping in units of huge pages is proposed. Through the method, operations performed by the Soc processor can be conducted without a separate program modification, and operations where the memory is a bottleneck can be accelerated through the PIM. Since there is no replacement cost for changing data mapping for sharing LLM parameters, both the response time and processing time of LLM inference can be shortened compared to existing techniques.

In particular, the effect of the embodiments of the present invention can be even more prominent when the LLM inference is performed by a single edge device. On-device LLM inference has various advantages compared to server-based LLM inference as it can be utilized inside a single device without transmitting personal information to the outside. The launch of on-device LLM services by various manufacturers, including Apple Intelligence of Apple, Samsung Galaxy AI of Samsung Electronics, and the like, attests to the importance.

As edge devices such as cellular phones, laptop computers, and the like have limited operations and memory resources due to limited form factors, it is general that a longer time is consumed for LLM inference compared to servers, and accordingly, when memory bottlenecks that most operations experience can be improved by applying the PIM, user experience may also be improved greatly, and additional effects such as reduction in battery consumption and the like can be obtained.

As a result, the embodiments of the present invention may solve the core problem that occurs in performing LLM inference by applying PIM to edge devices, and accelerate the LLM inference through the PIM without additional cost, and this bring practical experience of users and improvement of performance in billions of edge devices, including cellular phones, laptop computers, and the like, used by people around the world.

When on-device LLM inference, which is the core operation of many services such as chatbots, voice assistants, autocomplete, and the like, is to be accelerated through the PIM, the effect of improvement can be even more prominent.

The above descriptions are focused on LLM inference in applying the embodiments of the present invention. However, this is only an example, and it goes without saying that the present invention may be universally applied to other applications that can achieve mapping suitable for PIM, as well as LLM, by changing DRAM address mapping.

In addition, although the embodiments of the present invention focus on matrix-vector multiplication, which is a core operation of the LLM inference, it may also be applied to other operations that achieve data placement suitable for PIM operations through DRAM address mapping. Of course, it may also be applied to other applications that utilize matrix-vector multiplication with minimal modification.

It goes without saying that various embodiments of the present invention as described above can be implemented alone or in combination with other embodiments.

It should be understood that various embodiments of this document and the terms used herein are not intended to limit the technical features described in this document to specific embodiments, but include various modifications, equivalents, or substitutes of the embodiments. In connection with the description of drawings, similar reference numerals may be used for similar or related components. The singular form of a noun corresponding to an item may include one or more items, unless the related context clearly indicates otherwise.

In this document, each of phrases such as “A or B”, “at least one among A and B”, “at least either A or B”, “A, B, or C”, “at least one among A, B, and C”, and “at least either A, B, or C” may include all possible combinations of the items listed together in a corresponding phrase among the phrases. Terms such as “1st”, “2nd”, “first”, or “second” may be used only to distinguish a corresponding component from another corresponding component, and do not limit the components in any other aspect (e.g., importance or order). When a certain (e.g., a first) component is referred to as being “coupled” or “connected” to another (e.g., a second) component with or without a term such as “functionally” or “communicatively”, it means that the component may be connected to another component directly (e.g., wired), wirelessly, or through a third component.

The term “module” used in this document may include a unit implemented in hardware, software, or firmware, and may be used interchangeably with terms such as logic, logic block, part, or circuit. A module may be an integrally configured component, or a minimum unit of a component or a portion thereof that performs one or more functions. For example, according to an embodiment, a module may be implemented in the form of an application-specific integrated circuit (ASIC).

Various of embodiments this document may be implemented as software (e.g., a program) including one or more commands stored in a storage medium (e.g., a memory) that can be read by a device (e.g., an electronic device). The storage medium may include a random-access memory (RAM), a memory buffer, a hard drive, a database, an erasable programmable read-only memory (EPROM), an electrically erasable read-only memory (EEPROM), a read-only memory (ROM), and/or the like.

In addition, the processor in the embodiments of this document may call at least one command among one or more stored commands from the storage medium and execute the command. This allows the device to operate to perform at least one function according to the called at least one command. The one or more commands may include a code generated by a compiler or a code that can be executed by an interpreter. The processor may be a general-purpose processor, a Field Programmable Gate Array (FPGA), an Application Specific Integrated Circuit (ASIC), a Digital Signal Processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish the cases where data is stored semi-permanently on the storage medium from the cases where data is stored temporarily.

The method according to various embodiments disclosed in this document may be provided to be included in a computer program product. The computer program product may be traded between a seller and a buyer as goods. The computer program product may be distributed in the form of a machine-readable storage medium (e.g., a compact disc read only memory (CD-ROM)), or may be distributed online (e.g., downloaded or uploaded) through an application store (e.g., Play Store) or directly distributed between two user devices (e.g., smartphones). In the case of online distribution, at least a part of the computer program product may be at least temporarily stored in a machine-readable storage medium, such as a memory of a manufacturer's server, an application store's server, or a server, or may be temporarily generated.

According to various embodiments, each component (e.g., a module or a program) of the components described above may include a single or a plurality of entities. According to various embodiments, one or more of the components or operations of the components described above may be omitted, or one or more other components or operations may be added. Alternatively or additionally, a plurality of components (e.g., modules or a programs) may be integrated into a single component. In this case, the integrated component may perform one or more functions of each of the plurality of components in a way identical or similar to those performed by the corresponding component among the plurality of components before the integration. According to various embodiments, the operations performed by the modules, programs, or other components may be executed sequentially, in parallel, repeatedly, or heuristically, or one or more of the operations may be executed in a different order or omitted, or one or more other operations may be added.

According to an embodiment of the present invention, as a map ID for DRAM address mapping for sharing data between a Soc processor and a PIM processor is calculated, a new address mapping, rather than an existing mapping, can be used for huge pages containing shared data.

According to an embodiment of the present invention, unlike existing studies that design PIM only as an accelerator, a new method of integrating PIM into an existing system can be proposed, and in particular, LLM inference, which is a core application of on-device AI, can be improved.

According to an embodiment of the present invention, only minimal modification of the system and hardware may be required to be applicable to edge devices. For example, in the case of an operating system, only a modification for storing mapping information in the empty spaces of existing page table entries is required, and in the case of a memory controller, only simple logic for receiving mapping information, together with an address, and using a different address mapping technique according to the mapping information may be added.

According to an embodiment of the present invention, edge device manufacturers may adopt a mapping technique proposed in the present invention without large modification of the system, and particularly, in the case of cellular phone manufacturers actively developing and launching on-device LLM services, this may resolve the difficulty of adopting PIM and may also promote improvement in the quality of LLM services through adoption of the PIM.

Meanwhile, the effects of the present invention are not limited to those mentioned above, and unmentioned other technical effects will be clearly understood by those skilled in the art from the following descriptions.

### DESCRIPTION OF SYMBOLS

100: Device
110: Memory
112: PIM Processor
120: Processor
130: Input/Output Interface
140: Communication Interface

What is claimed is:

1. A method of performing matrix operations including a plurality of parameters by a system-on-chip (SoC) processor and a processing-in-memory (PIM) processor inside a memory, the method comprising the steps of:
calculating a map ID on the basis of at least one among information on the matrix, information on the memory, and information on the PIM processor;
allocating a huge page for representing some of the plurality of parameters; and
adding the map ID to a page table entry of the huge page for the matrix operation in the SoC processor.

2. The method according to claim 1, wherein information on the matrix includes information on a dimension of the matrix, and the map ID is a value representing how much a bit in charge of bank interleaving inside the memory is apart from a chunk column.

3. The method according to claim 2, wherein the step of calculating a map ID is performed by a mapping selector, and the step of allocating a huge page and the step of adding the map ID to a page table entry of the huge page are performed by a memory allocator.

4. The method according to claim 3, further comprising, before the step of calculating a map ID, the step of transmitting a memory allocation request by a user program to the mapping selector, together with information on the matrix.

5. The method according to claim 3, further comprising, after the step of adding the map ID to a page table entry of the huge page, the step of returning a virtual address of the huge page allocated by the memory allocator to a user program.

6. The method according to claim 1, wherein the matrix operation includes matrix-matrix multiplication and matrix-vector multiplication, wherein the matrix-matrix multiplication is performed by the SoC processor, and the matrix-vector multiplication is performed by the PIM processor.

7. The method according to claim 6, wherein the matrix operation is a weight matrix operation used for large language model (LLM) inference.

8. The method according to claim 7, wherein the LLM inference includes a prefill phase and a decode phase, wherein the prefill phase includes the matrix-matrix multiplication performed by the SOC processor, and the decode phase includes the matrix-vector multiplication performed by the PIM processor.

9. The method according to claim 8, wherein the LLM inference is performed by a single edge device.

10. The method according to claim 1, wherein information on the matrix includes at least one among information on a dimension of the matrix and information on a data type of the matrix.

11. The method according to claim 10, wherein information on the memory includes at least one among information on a size of the huge page of the memory, information on the number of channels of the memory, information on the number of ranks of the memory, and information on the number of banks of the memory.

12. The method according to claim 11, wherein information on the PIM processor includes information on a chunk column.

13. The method according to claim 12, wherein the map ID is determined to be different according to whether partitioning is needed, by comparing the size of the huge page with respect to a total number of banks in the memory with a row size of the matrix.

14. The method according to claim 1, further comprising the steps of:
receiving a virtual address for storing or loading the matrix from a user program, after the step of adding the map ID to a page table entry of the huge page;
determining a physical address corresponding to the virtual address; and
determining a DRAM address of the memory corresponding to the physical address on the basis of the physical address and the map ID.

15. The method according to claim 14, wherein the step of determining a DRAM address of the memory corresponding to the physical address is performed by a memory controller, a multiplexer of the memory controller receives the map ID as an input, and the memory controller includes a register for storing the map ID.

16. The method according to claim 14, wherein mapping between the DRAM address of the memory and the physical address is abstracted to the user program.

17. A computing device comprising:
a system-on-chip (SoC) processor; and
a memory including a processing-in-memory (PIM) processor, wherein
when a command related to a matrix operation stored in the memory is performed by the SoC processor and the PIM processor, the computing device performs:
an operation of calculating a map ID on the basis of at least one among information on the matrix, information on the memory, and information on the PIM processor;
an operation of allocating a huge page for representing some of the plurality of parameters; and
an operation of adding the map ID to a page table entry of the huge page for the matrix operation in the SoC processor.

18. A computer program stored in a non-transitory computer-readable recording medium, wherein the program executes operations of performing a matrix a operation including plurality of parameters by a system-on-chip (SoC) processor and a processing-in-memory (PIM) processor in the memory when the computer program is performed by a computing device, and the operations include:
an operation of calculating a map ID on the basis of at least one among information on the matrix, information on the memory, and information on the PIM processor;
an operation of allocating a huge page for representing some of the plurality of parameters; and
an operation of adding the map ID to a page table entry of the huge page for the matrix operation in the SoC processor.
